(19) United States
(12) Patent Application Publication
(10) Pub. No.: US 2011/0005733 A1
(43) Pub. Date: Jan. 13, 2011

(54) PIEZOELECTRIC FAN AND COOLING DEVICE USING PIEZOELECTRIC FAN

(75) Inventors: Hiroaki WADA, Kusatsu-shi (JP); Gaku KAMITANI, Kyoto-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/885,629

(22) Filed: Sep. 20, 2010

Related U.S. Application Data
(63) Continuation of application No. PCT/JP2009/054831, filed on Mar. 13, 2009.

(30) Foreign Application Priority Data
Mar. 21, 2008 (JP) 2008-072863

(51) Int. Cl. G06F 1/20

(52) U.S. Cl. 165/121

(57) ABSTRACT

A piezoelectric fan includes a piezoelectric vibrator that vibrates in a bending mode when a voltage is applied thereto and a plurality of parallel or substantially parallel blades connected to or integrated with the piezoelectric vibrator. The blades are arranged between heat-radiating fins of a heat sink such that the blades bend parallel or substantially parallel to side surfaces of the heat-radiating fins. A joint that connects the blades to each other is disposed at free ends in a longitudinal direction of the blades. When the blades are excited by the piezoelectric vibrator and warm air between the heat-radiating fins is blown, the joint prevents the blades from twisting.

### BACKGROUND OF THE INVENTION

1. Field of the Invention

The present invention relates to piezoelectric fans that blow warm air between heat-radiating fins of heat sinks by driving piezoelectric vibrators to vibrate in a bending mode so that blades connected to the piezoelectric vibrators are significantly bent.

2. Description of the Related Art

Recently, the development of devices to facilitate radiation of heat generated inside portable electronic devices has become an issue to be addressed with the decreasing size of electronic devices and the increasing density of mounted components. Cooling devices using piezoelectric fans have been proposed as devices for efficiently air-cooling such electronic devices.

Japanese Unexamined Utility Model Registration Application Publication No. 02-127796 discloses a radiator that includes a plurality of movable pieces attached to a rotatable shaft. The movable pieces are arranged between a plurality of heat-radiating fins disposed at a heat-generating portion of a heater so as to be parallel to each other with a predetermined spacing therebetween so that the radiator sends cool air to spaces between the heat-radiating fins and at the same time blows warm air between the heat-radiating fins by continuously rotating the rotatable shaft or by rocking the rotatable shaft in a predetermined angular range.

Japanese Unexamined Patent Application Publication No. 2002-339900 discloses a piezoelectric fan having a wind-generating oscillator including a piezoelectric element and outlets and inlets provided in the same surface. This piezoelectric fan includes a pair of partitions extending from an opening of a case body to the interior thereof such that both sides of the wind-generating oscillator are interposed between the partitions. Ports between each partition and either side of the case body define the inlets, and ports between both partitions define the outlets.

The radiator described in Japanese Unexamined Utility Model Registration Application Publication No. 02-127796 has an excellent heat-radiating effect since each movable piece forcibly blows warm air adjacent to the heat-radiating fins to the outside. However, it is inconvenient to use such a rotating blade type radiator as described in Japanese Unexamined Utility Model Registration Application Publication No. 02-127796 without changing the structure in view of a demand for a reduction in the size of electronic devices. Therefore, a small and lightweight piezoelectric fan as described in Japanese Unexamined Patent Application Publication No. 2002-339900, for example, may be used instead of the structure described in Japanese Unexamined Utility Model Registration Application Publication No. 02-127796. When the piezoelectric fan is used, the wind-generating capacity depends on the displacement of the piezoelectric element in the wind-generating oscillator. However, the displacement of the piezoelectric element is not as large as the movement of the movable pieces described in Japanese Unexamined Utility Model Registration Application Publication No. 02-127796. Therefore, in order to cool the interior of an electronic device as efficiently as possible, it is desirable that the interval between the partitions be as close to the same as the width of wind-generating plates (blades). That is, it is desirable for the gaps between the partitions and the blades to be reduced as much as possible.

Since the piezoelectric fan generates airflow by bending the blades, deformable and flexible blades are required. On the other hand, it is desirable that the gaps between the blades and both partitions (heat-radiating fins) be reduced as much as possible in order to provide efficient cooling. This promotes radiation of heat from the fins by directly “scraping” thermal boundary layers of the surfaces of the heat-radiating fins and an effect of increasing air flowing to the back of the fan by reducing air flowing backward from the blades through the gaps between the fins and the blades. However, this means that spaces into which air can easily flow are closed, and air resistance acting on the blades is significantly increased.

FIG. 10 illustrates a blade 51 that moves between heat-radiating fins 50. Ideally, the blade 51 is shifted parallel to the side surfaces of the heat-radiating fins 50 as indicated by a solid line. However, when the gaps between the blade 51 and the heat-radiating fins 50 are reduced, the blade 51 twists as indicated by a broken line such that the gaps between the blade and the heat-radiating fins 50 are increased since the blade 51 moves with a smaller air resistance. In FIG. 10, the blade 51 twists such that the left edge thereof moves upward and the right edge thereof moves downward. However, the blade 51 may twist in the opposite direction depending on the differences in the air resistance acting on the left and right edges of the blade. In some cases, the blade may exhibit complicated movement, such as torsional vibration, with which the blade recovers from the twisting state due to the spring stiffness thereof and twists in the opposite direction. When the blade is long and thin, contact between the ends of the blade and the heat-radiating fins may be observed due to the twisting deformation of the blade. Unexpected vibration, such as torsional vibration, adversely affects the durability and reliability of the piezoelectric fan, and the contact between the blade and the heat-radiating fins may lead to changes in the characteristics of the fan due to damage or abrasion in addition to noise generation.

### SUMMARY OF THE INVENTION

To overcome the problems described above, preferred embodiments of the present invention provide a highly durable and highly reliable piezoelectric fan including blades that are prevented from twisting when the blades are bent between heat-radiating fins of a heat sink.

A preferred embodiment of the present invention provides a piezoelectric fan arranged to blow warm air from between a plurality of heat-radiating fins of a heat sink, the fins being arranged parallel or substantially parallel to each other with a space interposed therebetween, including a piezoelectric vibrator arranged to vibrate in a bending mode when a voltage is applied thereto and a plurality of parallel or substantially parallel blades connected to or integral with the piezoelectric vibrator so as to be excited by the piezoelectric vibrator. A joint that connects the blades to each other is disposed in a portion of the blades from intermediate portions to free ends in a longitudinal direction of the blades.

The blades are resonated by connecting the piezoelectric vibrator to the blades and applying an AC voltage to the piezoelectric vibrator. Air between the heat-radiating fins can be replaced such that heat is efficiently radiated by driving the blades to vibrate between the heat-radiating fins. When the air between the heat-radiating fins is replaced using the piezoelectric fan, it is preferable that the piezoelectric fan include the plurality of blades corresponding to the plurality of heat-radiating fins arranged parallel or substantially parallel to each other, and it is preferable that the blades be arranged between the fins. The blades are prevented from twisting due to the blades being connected to each other via the joint disposed in the portion of the blades from the intermediate portions to the free ends in the longitudinal direction of the blades. Thus, contact between the blades and the heat-radiating fins can be prevented, and a highly durable and highly reliable piezoelectric fan can be obtained. Moreover, since gaps between the blades and the heat-radiating fins can be reduced to the greatest extent possible, warm air adjacent to the fins can be scraped, resulting in efficient cooling.

The piezoelectric vibrator according to a preferred embodiment of the present invention vibrates in a bending mode when a voltage is applied thereto, and may have various structures. For example, the piezoelectric vibrator may preferably be a unimorph vibrator defined by the blades and a piezoelectric element by attaching a single-plate piezoelectric element on main surfaces of the blades adjacent to first ends thereof. Moreover, the piezoelectric vibrator may preferably be a bimorph vibrator defined by two piezoelectric elements that expand or contract in opposite directions attached to on both surfaces of the blades. Furthermore, the piezoelectric vibrator may preferably include a piezoelectric element and a metallic plate bonded to each other separately from the blades. Although the amplitude of the piezoelectric vibrator while the vibrator is vibrating in a bending mode is very small, the amplitude of the piezoelectric vibrator can be amplified many times since the blades resonate with the piezoelectric vibrator. The blades may be metallic plates or resin plates, for example. The thickness, length, Young's modulus, and other characteristics of the blades can be selected as appropriate such that the blades can resonate in a first mode in accordance with the vibration of the piezoelectric vibrator.

A plurality of parallel or substantially parallel blades may preferably be connected to a single piezoelectric vibrator. Alternatively, a plurality of piezoelectric fans each including a blade connected to a piezoelectric vibrator may be arranged parallel or substantially parallel to each other. Furthermore, a substrate portion may be integrated with a plurality of blades, and a piezoelectric element may be attached on the substrate portion so that a piezoelectric vibrator is provided. The joint may be integral with the blades, or may be a separate member. When the joint has a rigidity greater than that of the blades, for example, torsional vibration may be more efficiently prevented. Moreover, when the joint is made of a material having a specific gravity greater than that of the blades, a weight is provided at the ends of the blades. With this weight, the moment of inertia caused by the weight is increased, and the displacement of the blades is increased.

The blades may preferably be arranged between the heat-radiating fins such that the blades bend parallel or substantially parallel to side surfaces of the heat-radiating fins, and at the same time, the free ends in the longitudinal direction of the blades can extend so as to protrude outward from the heat sink and be connected to each other by the joint. The blades are driven to resonate in a first vibration mode, which usually generates a maximum amplitude. At this moment, the amplitude and velocity of the blades are maximized at the ends thereof, and greatest air resistance acts on the ends of the blades. Due to the air resistance and separation from the fixed ends, twisting or torsional vibration is most easily generated at the ends of the blades. Therefore, the twisting or the torsional vibration can be most efficiently prevented by connecting the blades at the free ends thereof.

A groove may preferably be provided in an intermediate portion of each heat-radiating fin of the heat sink in a longitudinal direction of the fins, and the joint may be arranged in the grooves so as to be shiftable. In this case, the joint connects the blades at the position of the grooves arranged in the heat-radiating fins, that is, at intermediate portions of the blades, for example, and the joint does not protrude outward from the heat-radiating fins. This arrangement saves space. In this arrangement, a heat sink having a groove at an intermediate portion thereof is required. In the case of a heat sink attached using a Z-shaped clip, for example, a groove into which the clip is fitted is formed in advance. Therefore, the joint can be disposed in the groove.

As described above, a joint that connects a plurality of blades to each other is disposed in a portion of the blades from intermediate portions to free ends in a longitudinal direction of the blades according to the present invention. Thus, the blades are prevented from twisting when the blades vibrate between the heat-radiating fins and contact between the blades and the heat-radiating fins is effectively prevented. Furthermore, gaps between the blades and the heat-radiating fins can be reduced to the greatest extent possible so as to produce efficient cooling.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a cooling device including a piezoelectric fan according to a first preferred embodiment of the present invention.

FIG. 2 is a perspective view of the piezoelectric fan shown in FIG. 1.

FIG. 3 is an exploded perspective view of the piezoelectric fan shown in FIG. 1.

FIG. 4 is a cross-sectional view of an electronic device including the cooling device shown in FIG. 1.

FIG. 5 is a cross-sectional view taken along line V-V in FIG. 4.

FIG. 6 is an exploded perspective view of a piezoelectric fan according to a second preferred embodiment of the present invention.

FIG. 7 is a perspective view of a cooling device using a piezoelectric fan according to a third preferred embodiment of the present invention.

FIG. 8 is a perspective view of a cooling device using a piezoelectric fan according to a fourth preferred embodiment of the present invention.

FIGS. 9A to 9C illustrate piezoelectric fans according to various preferred embodiments of the present invention.

FIG. 10 illustrates a blade of a conventional piezoelectric fan that moves between heat-radiating fins.

### DETAILED DESCRIPTION OF THE PREFERRED EMBODIMENTS

Preferred embodiments of the present invention will now be described with reference to drawings.

### First Preferred Embodiment

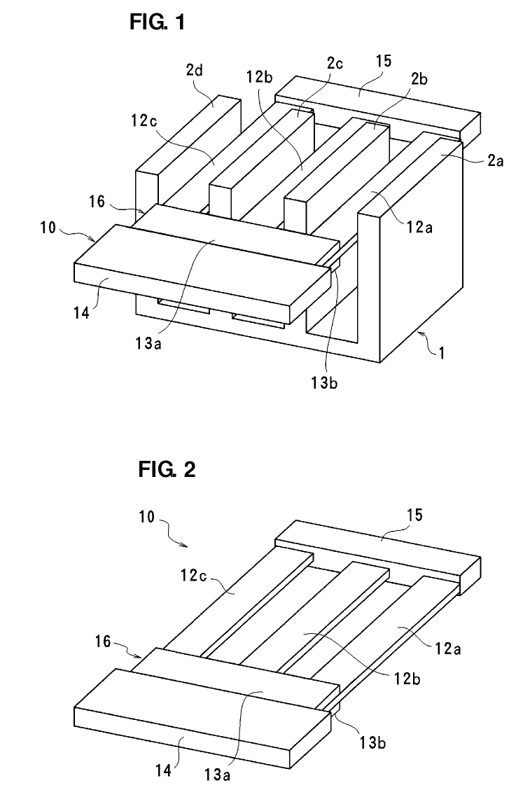

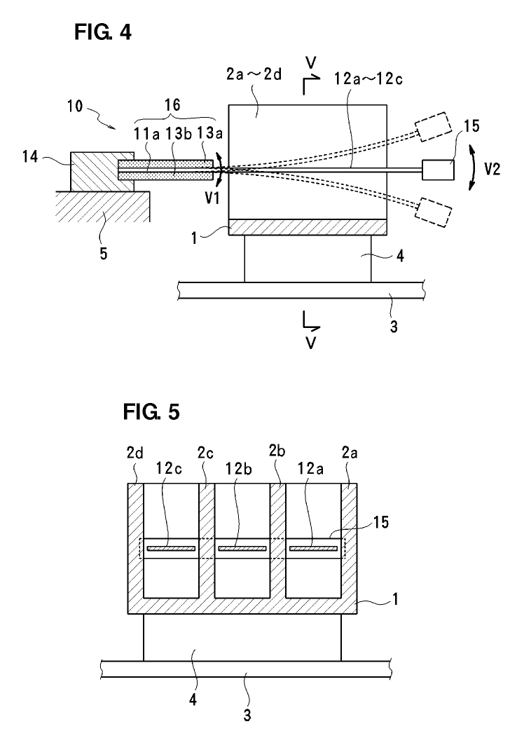

FIGS. 1 to 5 illustrate a piezoelectric fan according to a first preferred embodiment of the present invention used as a cooling device of a heat sink 1. The heat sink 1 includes a plurality of heat-radiating fins 2a to 2d arranged parallel or substantially parallel to each other with a space interposed therebetween. In this preferred embodiment, for example, four heat-radiating fins 2a to 2d are preferably provided. As shown in FIGS. 4 and 5, the heat sink 1 is attached to the top surface of a heating element 4, for example, a CPU, mounted on a circuit board 3 while the heat sink is thermally connected to the top surface. Therefore, heat generated at the heating element 4 is transmitted to the heat sink 1, and air between the heat-radiating fins 2a to 2d is heated.

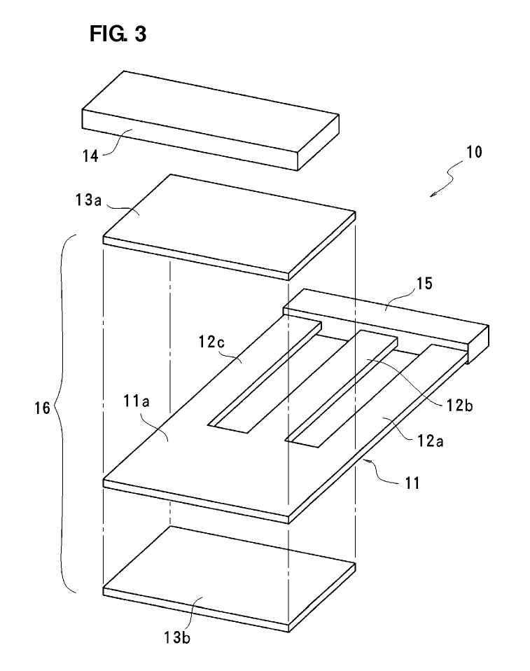

As shown in FIGS. 2 and 3, a piezoelectric fan 10 according to this preferred embodiment includes a metallic plate 11, preferably a stainless steel plate, for example, with a high spring elasticity. The metallic plate 11 includes a substrate portion 11a provided at an end in a longitudinal direction of the plate extending in a width direction of the plate. A plurality of strip-shaped blades 12a to 12c preferably having the same or substantially length and the same or substantially the same width extending parallel or substantially parallel to each other are integrated with the substrate portion 11a. Piezoelectric elements 13a and 13b are preferably attached on the top and bottom surfaces, respectively, of the substrate portion 11a of the metallic plate 11, and the substrate portion 11a and the piezoelectric elements 13a and 13b define a piezoelectric vibrator 16 of the bimorph type. A supporter 14 fixes and holds the substrate portion 11a and the piezoelectric elements 13a and 13b at an end of the substrate portion (opposite that from which the blades 12a to 12c extend). A joining member 15 is disposed at free ends of the blades 12a to 12c so as to connect the blades to each other. The blades 12a to 12c are arranged between the heat-radiating fins 2a to 2d, such that the blades are shifted parallel or substantially parallel to the side surfaces of the heat-radiating fins 2a to 2d. The supporter 14 is fixed to a fixing member 5, such as a case adjacent to the heat sink 1. The blades 12a to 12c pass through the heat-radiating fins 2a to 2d in a longitudinal direction of the fins, and the joining member 15 is disposed at the ends of the blades 12a to 12c protruding from the heat-radiating fins 2a to 2d. The joining member 15 synchronizes the displacement of the blades, and prevents the blades from twisting. The joining member 12 may be made of the same material as the metallic plate 11, or may be made of a different material, such as resin, for example. In order to effectively prevent twisting of the blades, it is preferable that the joining member 15 have a stiffness greater than that of the blades 12a to 12c. Moreover, the joining member 15 may preferably be made of a material having a specific gravity greater than that of the blades 12a to 12c such that the joining member 15 functions as a weight. In this case, the resonant frequency of the blades 12a to 12c is reduced by the joining member 15, and at the same time, the amplitude of the blades is increased.

The piezoelectric vibrator 16 vibrates in a bending mode with an amplitude V1 with respect to a longitudinal direction of the blades 12a to 12c (see FIG. 4) by applying AC voltages between an upper electrode of the piezoelectric element 13a and the metallic plate 11 that defines an intermediate electrode and between a lower electrode of the piezoelectric element 13b and the metallic plate 11. The blades 12a to 12c resonate with the vibration, and the free ends of the blades 12a to 12c vibrate with an amplitude V2 greater than that of the piezoelectric vibrator 16 (see FIG. 4). Since the blades 12a to 12c are shifted parallel or substantially parallel to the side surfaces of the heat-radiating fins 2a to 2d, warm air adjacent to the heat-radiating fins 2a to 2d is scraped by the blades 12a to 12c, and blown in the longitudinal direction of the blades 12a to 12c. Although the single piezoelectric elements 13a and 13b are attached on the top and bottom surfaces, respectively, of the metallic plate 11 in FIGS. 1 to 3, a plurality of piezoelectric elements may preferably be attached on each surface so that the blades are independently driven.

Although it is preferable that the gaps between the blades 12a to 12c and the heat-radiating fins 2a to 2d be reduced as much as possible for efficient cooling, this reduction easily causes twisting of the blades due to the air resistance acting on the blades. In this preferred embodiment, the blades are prevented from twisting due to the free ends of the blades 12a to 12c being connected to each other by the joining member 15. The movement will now be described with reference to FIG. 5. Ideally, the blades 12a to 12c move in parallel or substantially parallel while being arranged substantially perpendicular to the side surfaces of the heat-radiating fins 2a to 2d as shown in FIG. 5. However, when the gaps between the blades and the heat-radiating fins are small, a force in a twisting direction acts on each of the blades 12a to 12c since the blades attempt to move with a reduced air resistance. In particular, the twisting of the blades is maximized at the free ends, at which the velocity and amplitude are greatest. However, since the free ends of the blades 12a to 12c are connected to each other by the joining member 15, the blades 12a to 12c are prevented from twisting by the joining member 15, and can move in parallel or substantially in parallel while being arranged substantially perpendicular to the side surfaces of the heat-radiating fins 2a to 2d. Therefore, even when the gaps between the blades 12a to 12c and the heat-radiating fins 2a to 2d are small, the blades 12a to 12c are prevented from coming into contact with the heat-radiating fins 2a to 2d or from vibrating in a torsional mode.

When the blades were driven from about 50 Hz to about 100 Hz under conditions in which the length L of the heat-radiating fins was about 30 mm, the width D of the blades was about 4 mm, the thickness of the blades was about 100 μm, and the gaps between the heat-radiating fins and the blades were about 0.3 mm, for example, the blades were able to be stably driven without coming into contact with the heat-radiating fins.

### Second Preferred Embodiment

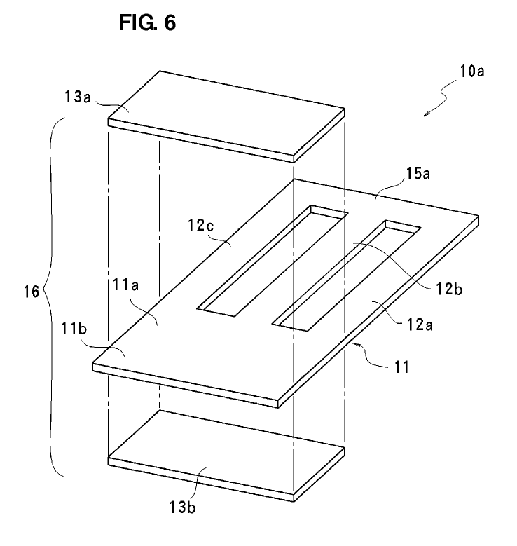

FIG. 6 illustrates a piezoelectric fan according to a second preferred embodiment of the present invention. In this preferred embodiment, the same reference numerals are used for components common to those in the first preferred embodiment, and the duplicated descriptions will be omitted. A piezoelectric fan 10a in this preferred embodiment includes a joint 15a that is integral with the blades 12a to 12c at free ends in a longitudinal direction of the blades 12a to 12c. An extending portion 11b extending opposite to a direction along which the blades extend is integrated with a substrate portion 11a. Piezoelectric elements 13a and 13b are not attached on the extending portion. This extending portion 11b is held by a supporter (not shown). Since the substrate portion 11a, the blades 12a to 12c, and the joint 15a are defined by one metallic plate in this case, the number of parts is greatly reduced, and the piezoelectric fan 10a can be produced at low cost. Moreover, since ends of the piezoelectric elements 13a and 13b are not restrained by the supporter, the piezoelectric elements 13a and 13b can be shifted more freely.

### Third Preferred Embodiment

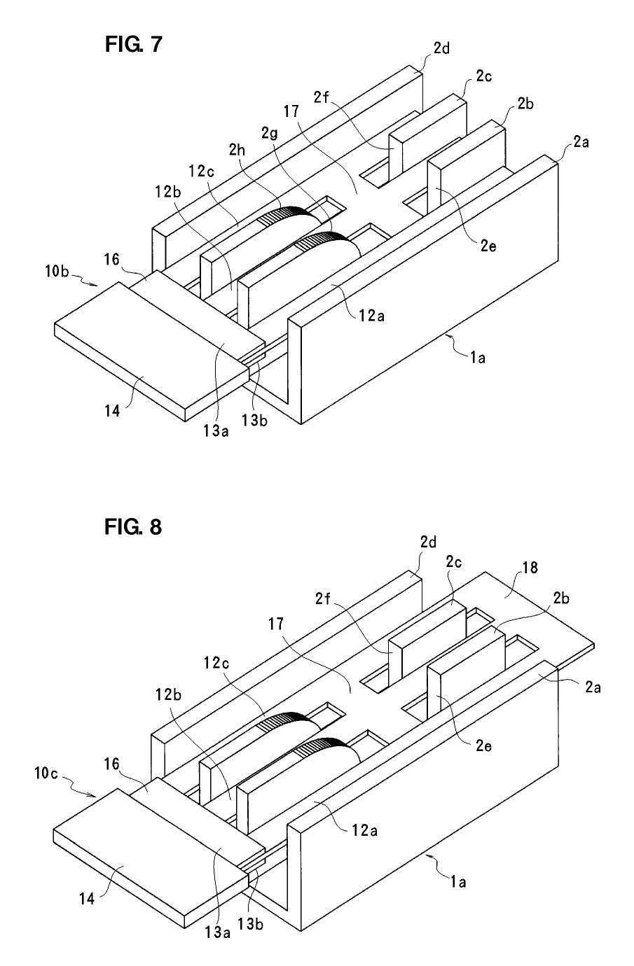

FIG. 7 illustrates a piezoelectric fan according to a third preferred embodiment of the present invention used as a cooling device of a heat sink 1a. In this preferred embodiment, the same reference numerals are used for components common to those in the first preferred embodiment, and the duplicated descriptions will be omitted. A piezoelectric fan 10b in this preferred embodiment includes blades 12a to 12c connected to each other by a joint 17 at intermediate portions in a longitudinal direction of the blades, and grooves 2e and 2f are provided at intermediate portions of heat-radiating fins 2b and 2c, respectively, of the heat sink 1a in a longitudinal direction thereof such that the position of the intermediate portions corresponds to that of the joint 17. Therefore, when the blades 12a to 12c are shifted in a thickness direction thereof, the joint 17 can freely move inside the grooves 2e and 2f in the vertical direction without coming into contact with the heat-radiating fins 2b and 2c.

In this preferred embodiment, free ends of the blades 12a to 12c are not connected to each other, and are located inside the heat sink 1a. Therefore, the blades 12a to 12c do not substantially protrude outward from the heat sink 1a, and the size of the blades is reduced. Although the joint 17 in this preferred embodiment is preferably integrated with the blades 12a to 12c, the joint may be an additional member, for example. Herein, the heat-radiating fins 2b and 2c divided by the grooves 2e and 2f include round chamfers 2g and 2h at edges adjacent to the piezoelectric vibrator 16 such that the edges are not brought into contact with the joint 17 when the blades 12a to 12c are shifted.

In this preferred embodiment, the grooves 2e and 2f are preferably provided only in the two heat-radiating fins 2b and 2c in the central portion of the heat sink 1a. However, grooves may be similarly provided in heat-radiating fins 2a and 2d at either side of the sink such that the grooves extend in a width direction of the blades. In this case, the heat sink 1a may preferably be attached to, for example, a circuit board by fitting a well-known Z-shaped clip into the grooves. Moreover, the piezoelectric fan 10 shown in FIG. 2 or the piezoelectric fan 10a shown in FIG. 6 can be incorporated into the above-described heat sink 1a. That is, the joining member or the joint provided at the free ends of the blades may be fitted into the grooves provided in the intermediate portions of the heat-radiating fins.

### Fourth Preferred Embodiment

FIG. 8 illustrates a piezoelectric fan according to a fourth preferred embodiment of the present invention used as a cooling device of a heat sink 1a. In this preferred embodiment, the same reference numerals are used for components common to those in the first preferred embodiment, and the duplicated descriptions will be omitted. A piezoelectric fan 10c in this preferred embodiment includes blades 12a to 12c connected to each other by a joint 17 at intermediate portions in a longitudinal direction of the blades and, in addition, connected by a joint 18 at free ends in the longitudinal direction of the blades. The joint 17 that connects the intermediate portions in the longitudinal direction of the blades is arranged in grooves 2e and 2f provided at intermediate portions of heat-radiating fins 2b and 2c, respectively, of the heat sink 1a as in the second preferred embodiment so as to be shiftable. The joint 18 that connects the free ends in the longitudinal direction of the blades protrudes outward from the heat sink 1a. Since the blades 12a to 12c are connected to each other at two positions in the longitudinal direction of the blades in this case, the blades are more effectively and reliably prevented from twisting.

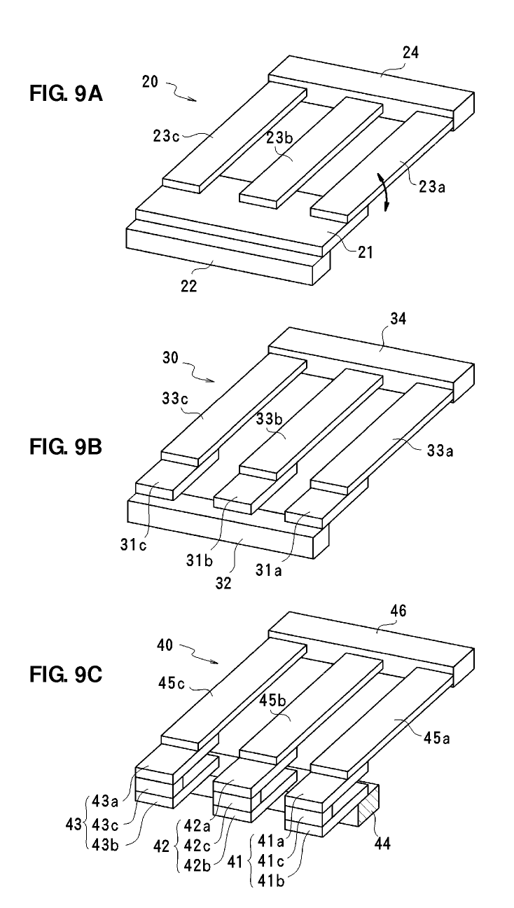

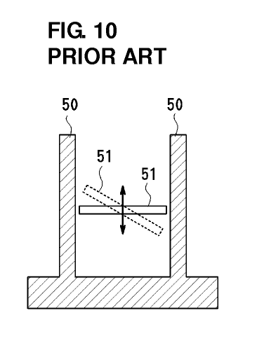

FIGS. 9A to 9B illustrate piezoelectric fans according to various preferred embodiments of the present invention. A piezoelectric fan 20 shown in FIG. 9A includes a piezoelectric vibrator 21 including a first end connected to a supporter 22 and a plurality of parallel or substantially parallel blades 23a to 23c attached to a second end of the piezoelectric vibrator 21 and connected to each other by a joining member 24 at free ends of the blades 23a to 23c. Although not shown, the blades 23a to 23c are preferably arranged between heat-radiating fins of a heat sink. The piezoelectric vibrator 21 vibrates in a bending mode in a direction of an arrow by applying an AC voltage, and may be a bimorph vibrator or a unimorph vibrator, for example.

A piezoelectric fan 30 shown in FIG. 9B includes a plurality of rectangular piezoelectric vibrators 31a to 31c including first ends in a longitudinal direction of the vibrators connected to a supporter 32 so as to be parallel or substantially parallel to each other and a plurality of blades 33a to 33c attached to second ends of the piezoelectric vibrators 31a to 31, respectively, in the longitudinal direction of the vibrators and connected to each other by a joining member 34 at free ends of the blades 33a to 33c. Herein, base ends of the blades 33a to 33c may extend in a longitudinal direction of the blades, and piezoelectric elements may be attached on one side or both sides of each extending portion so as to form a unimorph vibrator or a bimorph vibrator, for example.

A piezoelectric fan 40 shown in FIG. 9C includes three U-shaped piezoelectric vibrators 41 to 43 that support the blades 45a to 45c, respectively. The piezoelectric vibrators 41 to 43 include first vibrator elements 41a to 43a and second vibrator elements 41b to 43b. The first vibrator elements 41a to 43a are connected to the second vibrator elements 41b to 43b, respectively, via spacers 41c to 43c at first ends in a longitudinal direction of the vibrator elements so as to define U shapes. Second ends of the first vibrator elements 41a to 43a in the longitudinal direction thereof are connected to blades 45a to 45c, respectively, and second ends of the second vibrator elements 41b to 43b in the longitudinal direction thereof are supported by a supporter 44 so as to be parallel or substantially parallel to each other. Free ends of the blades 45a to 45c are connected to each other by a joining member 46. The first vibrator elements 41a to 43a and the second vibrator elements 41b to 43b preferably have the same or substantially the same vibration characteristics, and are preferably bent in directions opposite to each other. For example, when the first vibrator elements 41a to 43a are convex upward, the second vibrator elements 41b to 43b are concave downward. Therefore, a vibration having twice the amplitude of the vibrator elements is applied to the blades 45a to 45c, and the amplitudes of the blades 45a to 45c are increased accordingly. With this arrangement, the volume of air that is blown is greatly increased.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A piezoelectric fan arranged to blow warm air from between a plurality of heat-radiating fins of a heat sink, the fins being arranged parallel or substantially parallel to each other with a spacing interposed therebetween, the fan comprising:
a piezoelectric vibrator arranged to vibrate in a bending mode when a voltage is applied thereto; and
a plurality of parallel or substantially parallel blades connected to or integral with the piezoelectric vibrator so as to be excited by the piezoelectric vibrator; wherein
a joint connecting the plurality of blades to each other is provided in a portion of the plurality of blades from intermediate portions to free ends in a longitudinal direction of the plurality of blades.

2. The piezoelectric fan according to claim 1, wherein
a substrate portion is integrated with ends in the longitudinal direction of the plurality of blades opposite to the free ends so as to connect the plurality of blades in a width direction of the plurality of blades; and
the piezoelectric vibrator includes a piezoelectric element attached to at least one of a top surface and a bottom surface of the substrate portion.

3. The piezoelectric fan according to claim 1, wherein the joint has a rigidity greater than a rigidity of the plurality of blades.

4. The piezoelectric fan according to claim 1, wherein the joint is made of a material having a specific gravity greater than a specific gravity of the plurality of blades.

5. The piezoelectric fan according to claim 1, wherein the joint is integrated with the plurality of blades.

6. The piezoelectric fan according to claim 1, wherein
the plurality of blades are arranged between the plurality of heat-radiating fins such that the plurality of blades bend parallel or substantially parallel to side surfaces of the plurality of heat-radiating fins;
the free ends in the longitudinal direction of the plurality of blades protrude outward from the heat sink; and
the joint connects the free ends in the longitudinal direction of the plurality of blades protruding outward from the heat sink to each other.

7. The piezoelectric fan according to claim 1, wherein
a groove is provided in an intermediate portion of each of the plurality of heat-radiating fins of the heat sink in a longitudinal direction of the plurality of heat-radiating fins; and
the joint is arranged in the grooves so as to be shiftable.

8. A cooling device including a piezoelectric fan according claim 1 and the heat sink.
